(19) United States
(12) Patent Application Publication
(10) Pub. No.: US 2011/0241329 A1
(43) Pub. Date: Oct. 6, 2011

(54) DOUBLE-PAGE SPREAD STRUCTURE

(75) Inventors: Takaaki KIHARA, Niigata-shi (JP); Ryuzo AKEMA, Niigata-shi (JP)

(73) Assignees: Takaaki KIHARA, Niigata-shi (JP); Ryuzo AKEMA, Niigata-shi (JP); AKEMA PRINTING CO., LTD., Sanjo-shi (JP)

(21) Appl. No.: 13/051,512

(22) Filed: Mar. 18, 2011

(30) Foreign Application Priority Data
Mar. 31, 2010 (JP) 2010-084283
Oct. 29, 2010 (JP) 2010-243470
Feb. 21, 2011 (JP) 2011-034691

(51) Int. Cl. B42D 1/00

(52) U.S. Cl. 281/38

(57) ABSTRACT

An object of the invention is to provide an innovative double-page spread structure of extremely high product utility. The invention comprises a plurality of double-page spread parts 1, each of which double-page spread parts 1 having a configuration in which side margin parts of opposing page faces 1A are serially linked so that page leafs 1A can be spread out and layered in a folded-over manner, and adjacent double-page spread parts 1 having a configuration in which the side margin parts are serially linked and the double-page spread parts 1 can be spread out and layered in a folded-over manner.

### BACKGROUND OF THE INVENTION

1. Field of the Invention

The present invention relates to a double-page spread structure in which a three-dimensional figure appears when the double-page spread part is opened.

2. Description of the Related Art

In the past, double-page spread structures in which a three-dimensional body stands up when the double-page spread part is opened have been offered, for example, in JP (Utility Model) laid-open No. 07-27699 (referred to below as “conventional example”).

This conventional example, of course, has value as an artistic device used for appreciating three-dimensional bodies, but is also extremely useful as an instructive device that is used, for example, in the study of three-dimensional bodies.

### [Patent Documents]

[Patent document 1] JP (Utility Model) laid-open No. 07-27699)

### [Problems]

The inventors of the invention focused on double-page spread structures of the type described above in which a three-dimensional object stands up from the double-page spread part and developed an innovative double-page spread structure that has extremely high product value.

### SUMMARY OF THE INVENTION

A summary of the present invention is presented below in reference to the accompanying drawings.

A double-page spread structure according to the present invention has a plurality of double-page spread parts 1, wherein each of the double-page spread parts 1 is configured so that side margin parts of opposing page leafs 1A are serially linked, and the page leafs 1A can be spread out and layered in a folded-over manner; adjacent double-page spread parts 1 are configured so that the side margin parts are serially linked and the double-page spread parts 1 can be spread out as well as layered in a folded-over manner; and a three-dimensional body 2 that stands upright when the double-page spread part 1 is opened is provided to each of the double-page spread parts 1, so that a configuration is obtained in which, when the page leaf 1A and the double-page spread parts 1 are spread out, the three-dimensional bodies 2 of each of the double-page spread parts 1 are provided in parallel on the same flat surface.

According to the double-page spread structure of the first aspect, the three-dimensional body 2 is obtained by cutting out a part of the page leaf 1A and causing the part to stand upright.

According to the double-page spread structure of the second aspect, a cover leaf 3 that covers the cut-out part 7 of the page leaf 1A is provided on a bottom surface of the page leaf 1A.

According to the double-page spread structure of the third aspect, the side margin parts of the adjacent double-page spread parts 1 are serially linked and interposed by the cover leaf 3.

According to the double-page spread structure of the first aspect, a coating layer 12 made of a synthetic resin is provided on a surface of the page leaf 1A.

According to the double-page spread structure of the third aspect, a coating layer 12 made of a synthetic resin is formed on a surface of the cover leaf 3.

According to the double-page spread structure of the fourth aspect, the coating layer 12 made of a synthetic resin is formed on a surface of the cover leaf 3.

According to the double-page spread structure of the first aspect, each of the three-dimensional bodies 2 is a three-dimensional object of a scaled-down real object such as a building or animal.

According to the double-page spread structure of the first aspect, the structure has a first spreading part 4 obtained by serially linking a plurality of double-page spread parts 1 so as to be capable of being spread out in a prescribed direction, a second spreading part 6 obtained by serially linking a plurality of double-page spread parts 1 so as to be capable of being spread out in a prescribed direction, the second spreading part 6 being serially linked with the first spreading part 4 interposed by a fold-back part 5 and provided in parallel with the first spreading part 4, . . . , and an n^{th} spreading part (where n is a natural number of 2 or higher) obtained by serially linking a plurality of double-page spread parts 1 so as to be capable of being spread out in a prescribed direction, the n^{th} spreading part being serially linked with the n−1^{th} spreading part interposed by a fold-back part 5 and provided in parallel with the n−1^{th} spreading part.

According to the double-page spread structure of the first aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the second aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the third aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the fourth aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the fifth aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the sixth aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the seventh aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the eighth aspect, the structure has a first spreading part 4 obtained by serially linking a plurality of double-page spread parts 1 so as to be capable of being spread out in a prescribed direction; and a second spreading part 6 obtained by serially linking a plurality of double-page spread parts 1 so as to be capable of being spread out in a prescribed direction, the second spreading part being serially linked with the first spreading part 4 interposed by a fold-back part 5 and provided in parallel with the first spreading part 4.

According to the double-page spread structure of the first aspect, a plurality of double-page spread parts 1 are serially linked so as to be capable of being spread out in an annular configuration.

According to the double-page spread structure of the second aspect, a plurality of double-page spread parts 1 are serially linked so as to be capable of being spread out in an annular configuration.

According to the double-page spread structure of the third aspect, a plurality of double-page spread parts 1 are serially linked so as to be capable of being spread out in an annular configuration.

According to the double-page spread structure of the fourth aspect, a plurality of double-page spread parts 1 are serially linked so as to be capable of being spread out in an annular configuration.

According to the double-page spread structure of the fifth aspect, a plurality of double-page spread parts 1 are serially linked so as to be capable of being spread out in an annular configuration.

According to the double-page spread structure of the sixth aspect, a plurality of double-page spread parts 1 are serially linked so as to be capable of being spread out in an annular configuration.

According to the double-page spread structure of the seventh aspect, a plurality of double-page spread parts 1 are serially linked so as to be capable of being spread out in an annular configuration.

According to the double-page spread structure of the eighth aspect, a plurality of double-page spread parts 1 are serially linked so as to be capable of being spread out in an annular configuration.

### EFFECT OF THE INVENTION

As a result of the configuration described above, this embodiment, of course, allows the three-dimensional bodies that are erected in each of the double-page spread parts to be individually viewed by opening the opposing page leafs that constitute each of the double-page spread parts in succession, but when the double-page spread parts are spread out, the three-dimensional bodies of each of the double-page spread parts that are provided in parallel can be viewed and compared simultaneously, so that the three-dimensional bodies can be experienced perceptually in a manner impossible heretofore, making them optimal as instructional materials, for example, and producing an innovative double-page spread structure with extremely high product value.

### BRIEF DESCRIPTION OF THE DRAWINGS

FIG. 1 is a perspective view of Embodiment 1;

FIG. 2 is a perspective view that describes the essential parts in Embodiment 1;

FIG. 3 is a perspective view depicting a production method of Embodiment 1;

FIG. 4 is an explanatory sectional view of the essential parts of Embodiment 1;

FIG. 5 is an explanatory view of the essential parts of Embodiment 1;

FIG. 6 is a perspective view for describing the essential parts of Embodiment 1;

FIG. 7 is a perspective view for describing a production method for Embodiment 1;

FIG. 8 is a plan view for describing the essential parts of Embodiment 1;

FIG. 9 is a summary operational diagram for describing the essential parts of Embodiment 1;

FIG. 10 is a summary operational diagram for describing the essential parts of Embodiment 1;

FIG. 11 is a summary operational diagram for describing the essential parts of another example of Embodiment 1;

FIG. 12 is a perspective view for describing the essential parts of Embodiment 2;

FIG. 13 is a perspective view depicting a production method for Embodiment 2;

FIG. 14 is a summary operational diagram for describing the essential parts of Embodiment 2;

FIG. 15 is a perspective view showing the production method of Embodiment 3;

FIG. 16 is a summary operational diagram for describing the essential parts of Embodiment 3;

FIG. 17 is a summary operational diagram for describing the essential parts of Embodiment 3;

FIG. 18 is a summary operational diagram for describing the essential parts of Embodiment 3; and

FIG. 19 is a summary operational diagram for describing the essential parts of Embodiment 3.

### DESCRIPTION OF THE PREFERRED EMBODIMENTS

Preferred embodiments of the present invention are described briefly below in reference to the drawings, thereby indicating the operation of the present invention.

When the each double-page spread part 1 is opened, a three-dimensional body 2 is erected in each double-page spread part 1.

Specifically, for example, when the opposing page leafs 1A that constitute each of the plurality of double-page spread parts 1 are opened in succession as when reading a book, a three-dimensional body 2 is erected in each double-page spread part 1, and these three-dimensional bodies 2 can be viewed individually.

In addition, the double-page spread parts 1 can be spread out like an accordion, and when the double-page spread parts 1 have been spread out, the three-dimensional bodies 2 of the double-page spread parts 1 are situated in parallel on the same flat surface.

Consequently, the erected three-dimensional bodies 2 can be viewed simultaneously on each double-page spread part 1, and when each three dimensional body 2 is a famous building, for example, the sizes and shapes of the famous buildings can be compared via the three-dimensional bodies 2, allowing a type of sensual experience of the three-dimensional bodies 2 that has not been achieved in the past, which is optimal, for example, as an instructional device.

### Embodiment 1

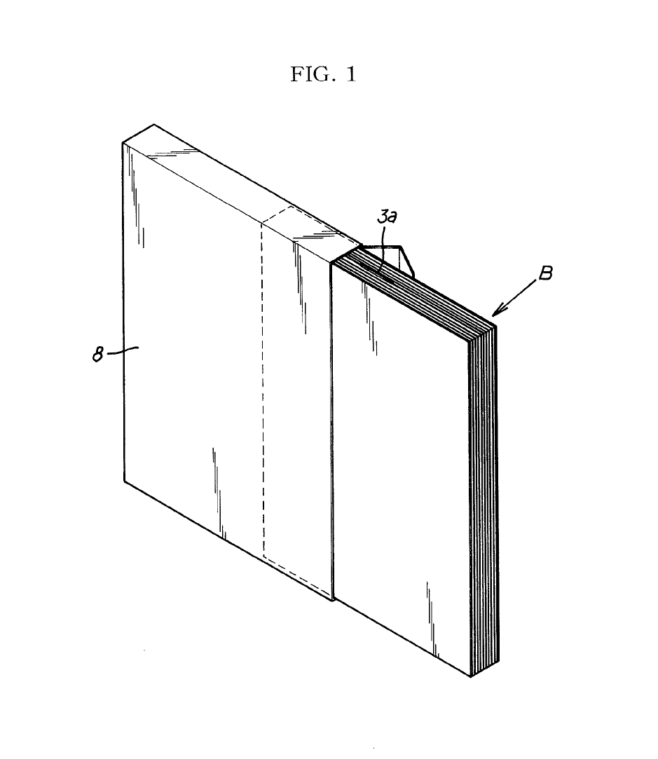

Embodiment 1 of the present invention is described in detail in reference to FIGS. 1 to 11.

This embodiment is a double-page spread structure B having a plurality of double-page spread parts 1, with each double-page spread part 1 being configured so that the side margin parts of the opposing page leafs 1A are serially linked, and the page leafs 1A can be spread out as well as layered in a folded-over manner; and the adjacent double-page spread parts 1 are constituted so that the side margin parts are serially linked, and the double-page spread parts 1 can be spread out as well as layered in a folded-over manner. The numeral 8 denotes a case body that contains the double-page spread structure B.

In this embodiment, both the page leafs 1A and cover leafs 3 described below are made from paper and formed into square (rectangular) shapes.

In addition, a coating layer 12 may be formed on the surfaces that constitute the outside of the respective page leafs 1A and cover leafs 3 by carrying out processing with a synthetic resin member having suitable flexibility (e.g., polypropylene processing).

Consequently, this coating layer 12 provides superior durability by preventing damage due to wetting with water, thereby providing the ability to withstand repeated use. For example, sufficient strength is thereby provided that will allow infants or visually impaired persons to apprehend the three-dimensional bodies 2 through forceful touching of the three-dimensional bodies 2.

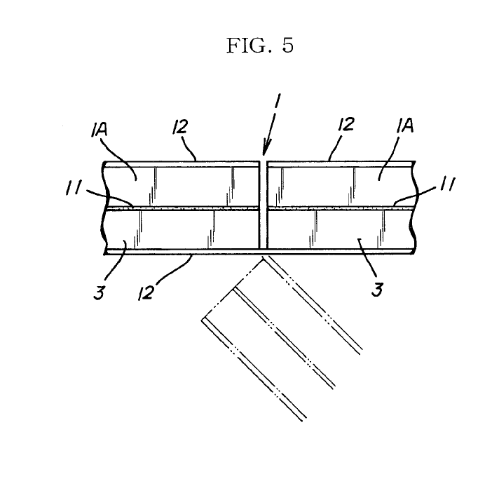

In addition, the coating layer 12 that is formed on the surfaces of each of the page leafs 1A constitutes the linking part for the opposing page leafs 1A that constitute the double-page spread part 1. In addition, the coating layer 12 that is formed on the surface of the cover leaf 3 constitutes the linking part for the double-page spread parts 1 (refer to FIG. 5). Any of the linking parts can also fold up by virtue of being serially linked by the coating layer 12.

The page leaf 1A and cover leaf 3 are not limited to paper. A material that is thin and resists bending may also be appropriately used.

Moreover, a three-dimensional body 2 that stands up when the double-page spread part 1 is opened may be provided on each of the double-page spread parts 1.

This three-dimensional body 2 is made to stand up as a result of part of the page leaf 1A having been cut out, and the body can thus be viewed from any direction across 360°. Part of the three dimensional body 2 (in a location that is not cut-out) is linked with the page leaf 1A.

The three-dimensional body 2 that is provided in each double-page spread part 1 is a three-dimensional body obtained by miniaturization of an actual object, such as a building or animal, using the same scale.

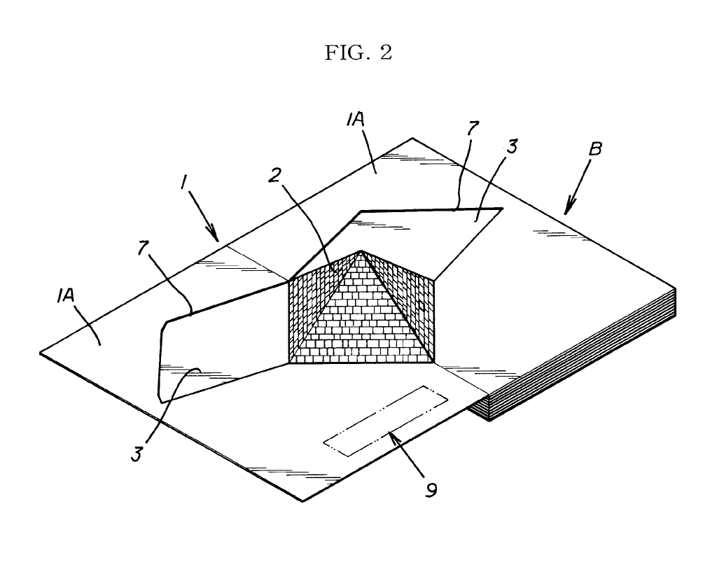

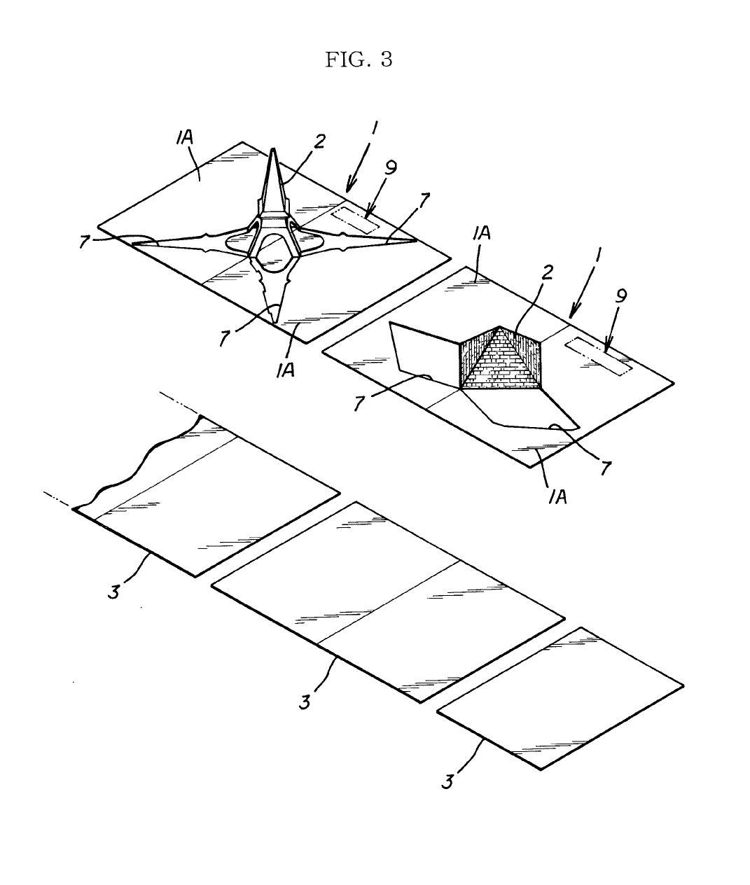

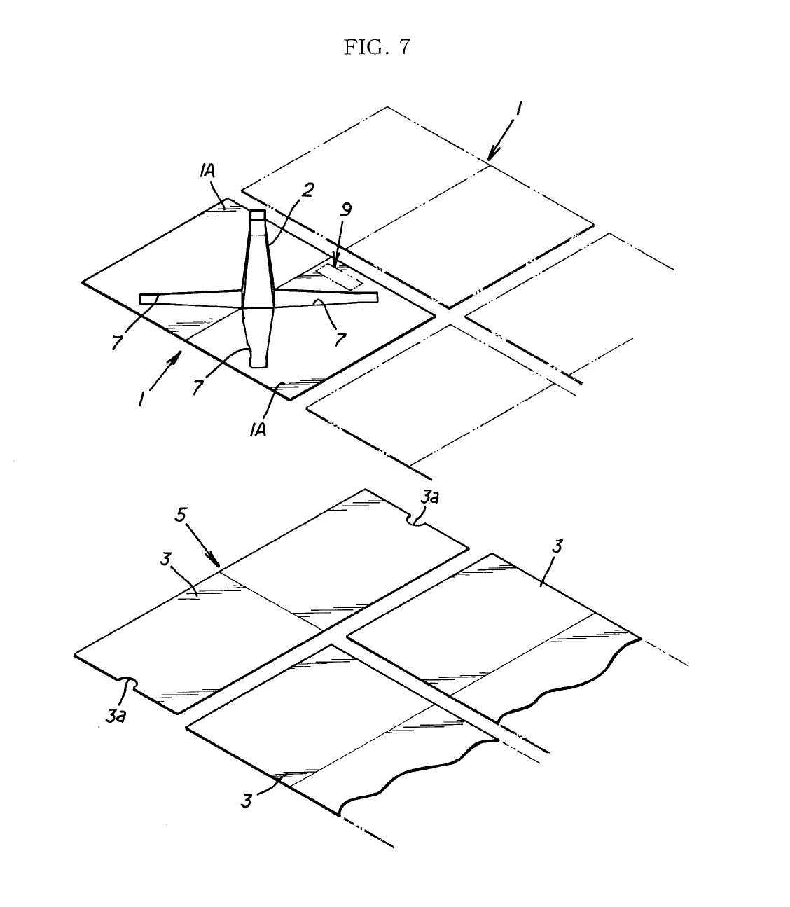

Specifically, in this embodiment, a pyramid or the Tokyo Tower depicted in FIGS. 2 and 3 may be used as the three-dimensional body 2, or a three-dimensional body 2 may be produced that depicts the Yokohama Landmark Tower as shown in FIG. 7. The three-dimensional bodies 2 may have sizes resulting from miniaturization using the same scale.

In addition, a Braille section 9 for visually impaired persons may be provided at a location near the three-dimensional body 2 on the surface of the page leaf 1A.

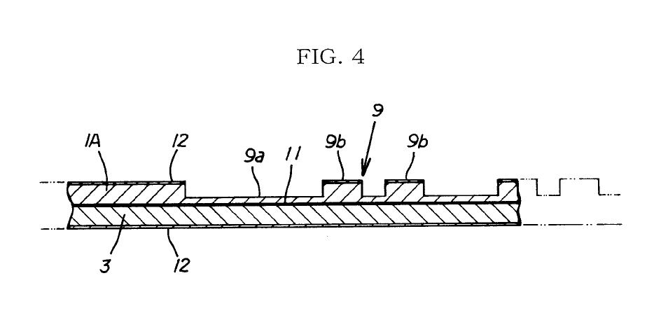

This Braille section 9 is produced by indentation of prescribed locations of the page leaf 1A using a laser as shown in FIG. 4 and is constituted by dot-shaped protrusions 9b that indicate the name or provide an explanation of the three-dimensional body 2 within a plan view-type recess part 9a.

In addition, a cover leaf 3 that conceals the cutout part 7 of the page leaf 1A with the three-dimensional body 2 cut out as shown in FIG. 3 is glued to the back face of the page leaf 1A.

The cover leaf 3, as depicted in FIG. 3, is a square (rectangular) shape having the surface area of one of the page leafs 1A or two of the page leafs 1A. In the former case, the cover leaf is glued via an adhesive member 11 to the back surface of the page leaf 1A situated at the end part (leader and trailer). In the latter case, the cover leaf is glued via an adhesive member 11 that spans the page leafs 1A to the back surfaces of each of the page leafs 1A that constitute adjacent double-page spread parts 1. Specifically, adjacent double-page spread parts 1 are serially linked via the cover leaf 3.

The double-page spread structure B of this embodiment is constituted by linkage in series of a plurality of double-page spread parts 1 so as to be capable of being spread out to produce a serpentine configuration.

Specifically, the double-page spread structure B has a first spreading part 4 produced by serially linking a plurality of double-page spread parts 1 so as to be capable of being spread out in a prescribed direction, a second spreading part 6 produced by serially linking a plurality of double-page spread parts 1 so as to be capable of being spread out in a prescribed direction, provided in parallel with the first spreading part 4 and serially linked with the first spreading part 4 via a fold-back part 5; . . . , and an n^{th} spreading part (where n is a natural number of 2 or greater) produced by serially linking a plurality of double-page spread parts 1 so as to be capable of being spread out in a prescribed direction, provided in parallel with an n−1^{th} spreading part and serially linked with the n−1^{th} spreading part via a fold-back part 5.

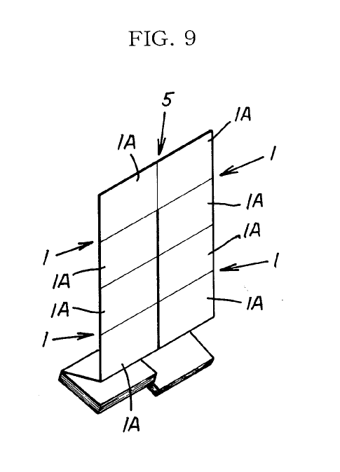

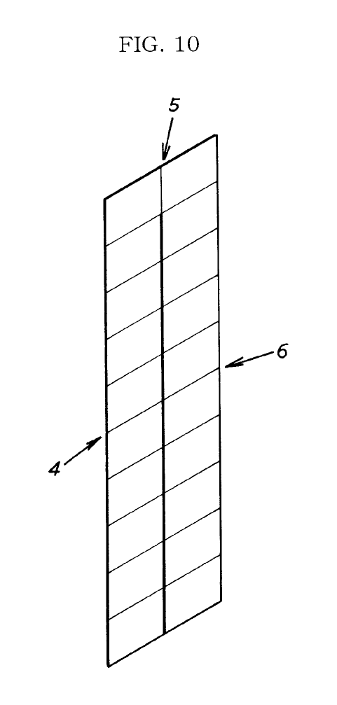

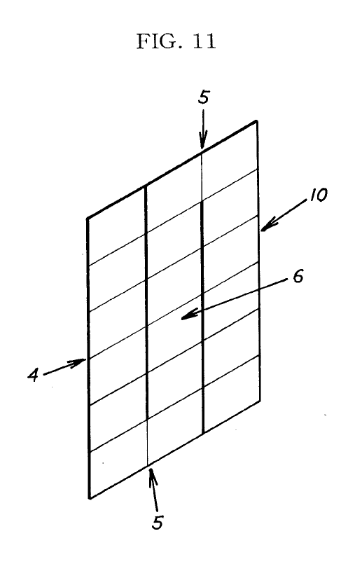

FIGS. 9 and 10 show disposition of up to the second spreading part 6. FIG. 11 shows disposition of up to a third spreading part 10, provide in parallel with the second spreading part 6 and serially linked with the second spreading part 6 via a fold-back part 5.

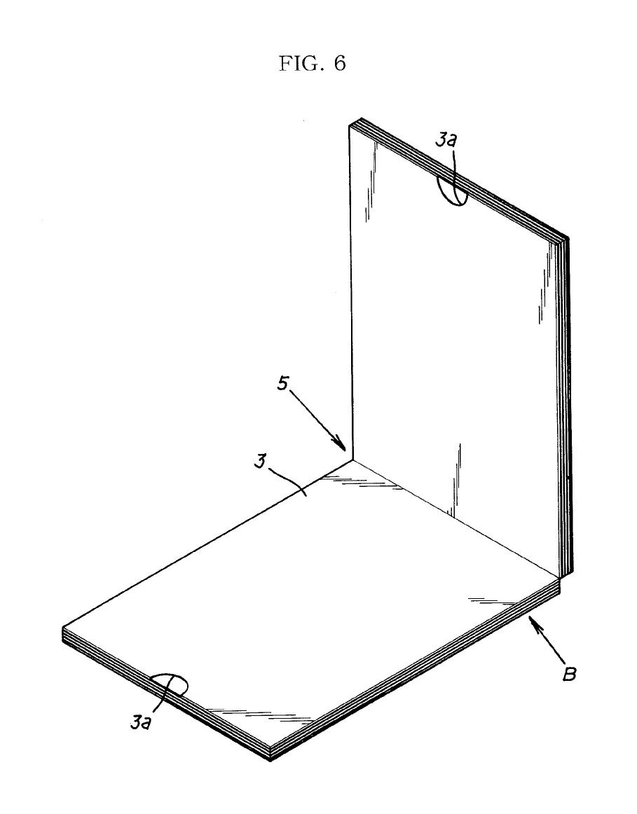

This fold-back part 5 that links in series the respective spreading parts is constituted by gluing the cover leaf 3 having a surface area of two of the page leafs 1A to the back surfaces of the page leafs 1A of the double-page spread parts 1 situated at the ends of the respective opening parts as shown in FIGS. 6 and 7.

In addition, in this embodiment, a depression part 3a is provided at the left and right side margins of the cover leaf 3 that constitutes the fold-back part 5 as shown in FIG. 7. This depression part 3a provides the function of indicating the position of the fold-back part 5, and by holding this depression part 3a, the double-page spread structure B is spread in vertical divisions (refer to FIG. 6). In this condition, the sites other than the fold-back part 5 are allowed to fall down, so that the other sites spread out all at together (refer to FIGS. 9, 10).

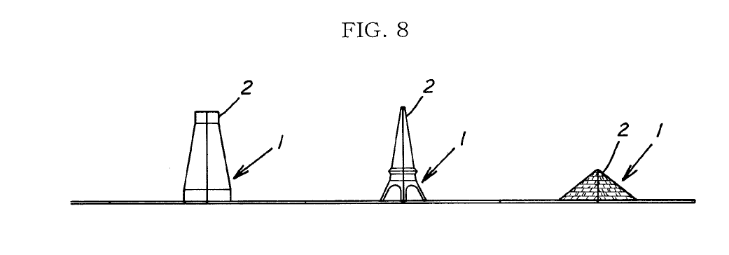

In the above configuration pertaining to this embodiment, the three-dimensional bodies 2 of the double-page spread parts 1 are provided in parallel on the same flat surface when the double-page spread parts 1 are spread out (refer to FIG. 8).

The method for producing this embodiment is described below.

First, a design drawing (developed view) of the three-dimensional body 2 is input into a laser device (not shown in the figures) that emits laser light. The design drawing for the three-dimensional body 2 is made so that the three-dimensional body 2 is formed when the double-page spread parts are opened to 180°, and so that the three-dimensional body 2 is contained in the cutout parts 7 when the page leafs 1A are folded up and closed.

Next, the laser light emitted by the laser device is used in order to cut out the three-dimensional body 2 forming the cut-out parts 7 and in order to form the Braille part 9 based on the design drawing.

In this embodiment, a configuration is used in which the laser light of a prescribed width emitted by the laser device is used in order to carry out the cut-out operation described above or the operation for forming the Braille parts. However, the cut-out operation described above may also be carried out, for example, by irradiation with laser light having a wide width, which is passed through a frame (mask) to produce, laser light of the prescribed width (the slit width formed by the frame). In such a case, mass production capability is enhanced.

Next, the three dimensional body model that has been cut out by irradiation with laser light is assembled into the three-dimensional body 2 by folding at the respective folding sites, or by gluing at gluing tab parts. Because the gluing tab parts becomes thick when gluing tab parts are provided, for example, a joining member that is formed from a thin material such as washi paper may be used instead of the gluing tab parts.

Next, the page leafs 1A having the three-dimensional bodies 2 are serially linked to allow the double-page spread parts 1 to fold up and stack, and adjacent double-page spread parts 1 are serially linked to allow them to fold up and stack and spread out.

As a result of the configuration described above, this embodiment allows the three-dimensional bodies 2 that are erected in each of the double-page spread parts 1 to be individually viewed by opening the opposing page leafs 1A that constitute each of the double-page spread parts 1 in succession. However, when the double-page spread parts 1 are spread out, the three-dimensional bodies 2 of each of the double-page spread parts 1 are also provided in parallel and can be viewed and compared simultaneously (allowing cataloging), so that the three-dimensional bodies 2 can be experienced perceptually in a manner impossible heretofore, making the invention optimal as an instructional device, for example.

In addition, in this embodiment, the three-dimensional bodies 2 are made to stand up as a result of parts of the page leafs 1A having been cut out, so that bulking and thickening of the three-dimensional portions will not occur when closed. Production is also simplified, which facilitates mass production. Furthermore, because the three-dimensional bodies 2 are portions that have been cut out from the page leafs 1A, production of waste during manufacture can be minimized.

Moreover, in this embodiment, a cover leaf 3 was provided for covering the cutout part 7 of the page leaf 1A on the bottom face of the page leaf 1A, and thus the cut-out part 7 will not be noticed, improving appearance. Moreover, the strength of the page leaf 1A is increased.

Furthermore, in this embodiment, a configuration is used in which the side margin parts of adjacent double-page spread parts 1 are serially linked via the cover leaf 3, so that the double-page spread parts 1 can be folded up and stacked. Consequently, the structure is extremely efficient and also leads to superior mass production capability and cost.

Moreover, in this embodiment, the three-dimensional bodies 2 are three-dimensional objects that result from miniaturization of actual objects such as buildings or animals and are produced at the same scale. Consequently, the three-dimensional bodies can be perceptually experienced in a manner not possible in the past.

Moreover, this embodiment has a first spreading part 4 produced by serially linking a plurality of double-page spread parts 1 so as to be capable of being spread out in a prescribed direction, a second spreading part 6 produced by serially linking a plurality of double-page spread parts 1 so as to be capable of being spread out in a prescribed direction, provided in parallel with the first spreading part 4 and serially linked with the first spreading part 4 via a fold-back part 5; . . . , and an n^{th} spreading part (where n is a natural number of 2 or greater) produced by serially linking a plurality of double-page spread parts 1 so as to be capable of being spread out in a prescribed direction, provided in parallel with an n−1^{th} spreading part and serially linked with the n−1^{th} spreading part via a fold-back part 5. As a result, for example, a plurality of three-dimensional bodies 2 can be provided in parallel on the same flat surface within a small space, such as on a desk, which is superior in terms of use as an instructional material.

In this embodiment, a coating layer 12 that is formed from synthetic resin is also formed on the surface of the page leaf 1 and the cover leaf 3, which leads to dramatically improved durability.

### Embodiment 2

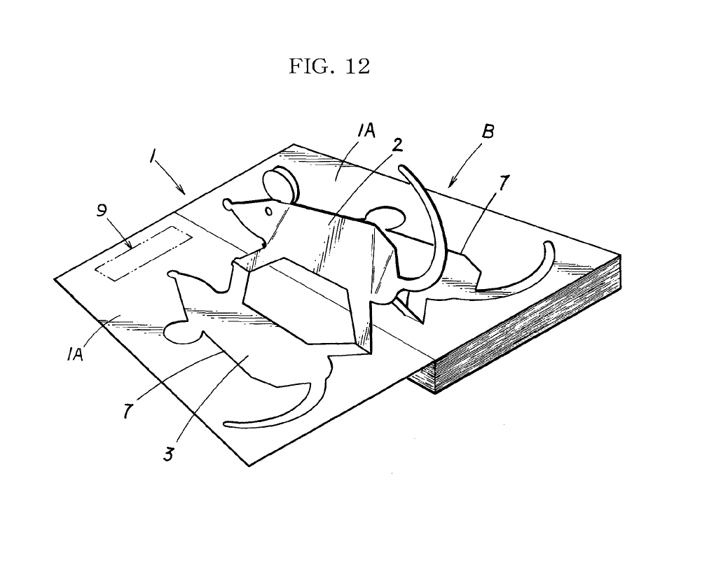

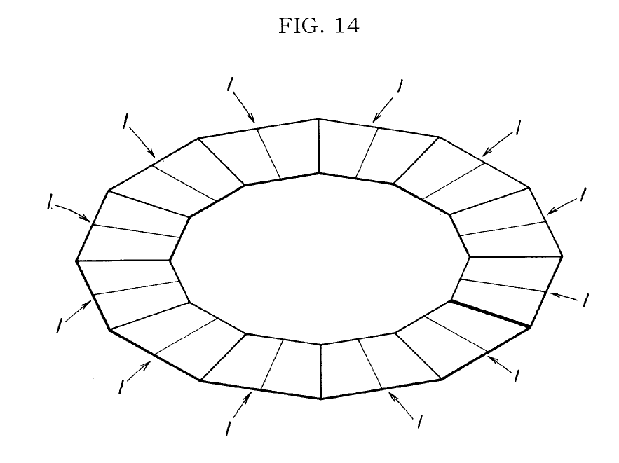

Embodiment 2 of the present invention is described in detail in reference to FIGS. 12 to 14.

In this embodiment, a configuration is produced in which a plurality of double-page spread parts 1 are serially linked so as to be capable of being spread out into a ring, and when the page leafs 1A and the double-page spread parts 1 are spread out, the three-dimensional body 2 of each double-page spread part 1 is provided in parallel in the shape of a ring on a single flat surface. Although not shown in the figures, the double-page spread structure B pertaining to this embodiment is also contained in a case body.

Specifically, in this embodiment, all of the cover leafs 3 described below and the page leafs 1A are made from paper and have a square shape (front-view trapezoidal shape).

In addition, a coating layer is formed on the surfaces that constitute the outsides of the cover leafs 3 and the page leafs 1A by carrying out processing with a synthetic resin member having suitable flexibility (e.g., polypropylene processing).

Consequently, this coating layer prevents damage due to wetting with water, resulting in superior durability and the ability to withstand repeated use. For example, sufficient strength is thereby provided that will allow infants or visually impaired persons to apprehend the three-dimensional body 2 by forceful touching of the three-dimensional body 2.

In addition, the coating layer 12 that is formed on the surfaces of each of the page leafs 1A constitutes the linking part for the opposing page leafs 1A that constitute the double-page spread part 1. In addition, the coating layer 12 that is formed on the surfaces of the cover leafs 3 constitutes linking parts for the double-page spread parts 1, and any of the linking parts can fold up by being serially linked by the coating layer 12.

The page leaf 1A and cover leaf 3 are not limited to paper. A material that is thin and resists bending may also be appropriately used.

In this embodiment, twelve double-page spread parts 1 are provided by a combination of the page leafs 1A and the cover leafs 3 described above.

In addition, a three-dimensional body 2 that stands up when the double-page spread part 1 is opened is provided for each of the double-page spread parts 1.

This three-dimensional body 2 is made to stand up as a result of part of the page leaf 1A having been cut out, and the body can thus be viewed from any direction across 360°. Part of the three dimensional body 2 (in a location that is not cut-out) is linked with the page leaf 1A.

The three-dimensional body 2 that is provided in each double-page spread part 1 is a three-dimensional body obtained by miniaturization of an actual object, such as a building or animal, using the same scale.

Specifically, in this embodiment, the three-dimensional body 2 is represented a rat as shown in FIG. 12, and three-dimensional bodies 2 of the animals that make up the zodiac can be produced by providing twelve double-page spread parts 1, not shown in the figures.

In addition, a Braille section 9 for visually impaired persons may be provided at a location near the three-dimensional body 2 on the surface of the page leaf 1A.

This Braille section 9 is produced by indentation of prescribed locations of the page leaf 1A using a laser and is constituted by dot-shaped protrusions that indicate the name or provide an explanation of the three-dimensional body 2 within a plan view-type recess part.

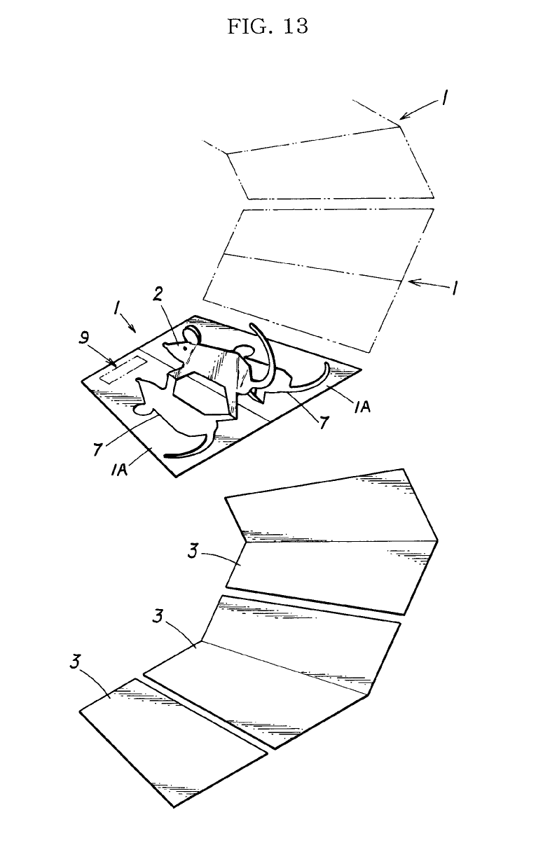

In addition, a cover leaf 3 that conceals the cutout part 7 of the page leaf 1A with the three-dimensional body 2 cut out as shown in FIG. 13 is glued to the back face of the page leaf 1A.

The cover leaf 3, as depicted in FIG. 13, is a square (rectangular) shape having the surface area of one of the page leafs 1A or two of the page leafs 1A. In the former case, the cover leaf is glued via an adhesive member to the back surface of the page leaf 1A situated at the end part (leader and trailer). In the latter case, the cover leaf is glued, via an adhesive member that spans the page leafs 1A, to the back surfaces of each of the page leafs 1A that constitute adjacent double-page spread parts 1. Specifically, adjacent double-page spread parts 1 are serially linked via the cover leaf 3.

The double-page spread structure B of this embodiment is constituted by serially linking a plurality of double-page spread parts 1 so as to be capable of being opened up from the shape of a page leaf 1A and spread out to produce a serpentine configuration.

As a result of the above configuration, in this embodiment, the three-dimensional bodies 2 of the double-page spread parts 1 are placed in parallel in the shape of a ring on the same flat surface when the double-page spread parts 1 are opened up.

The remainder of the configuration is the same as in Embodiment 1.

### Embodiment 3

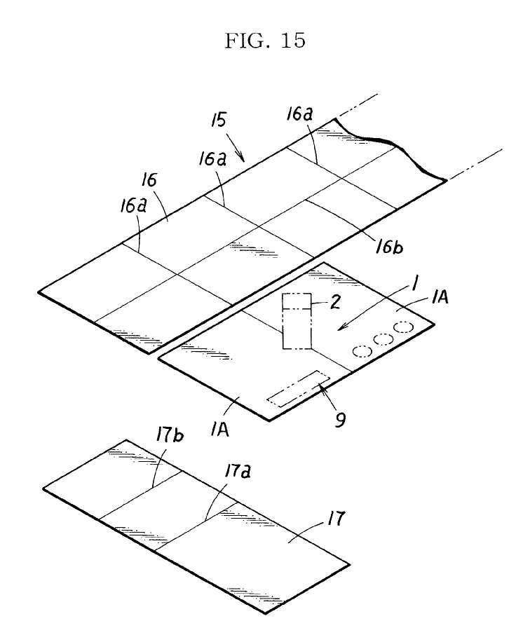

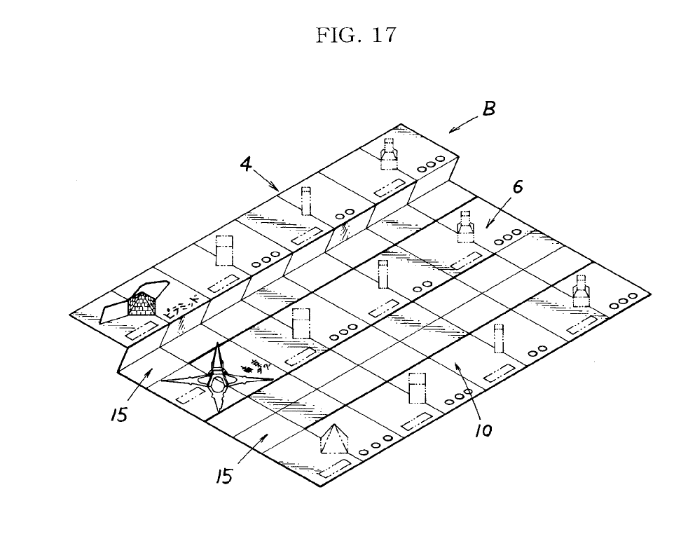

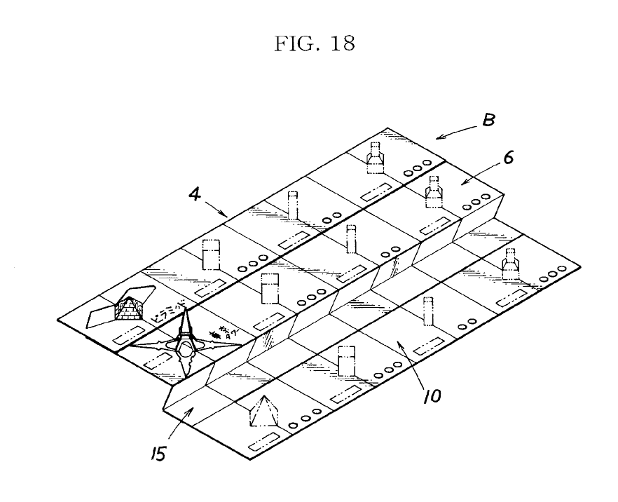

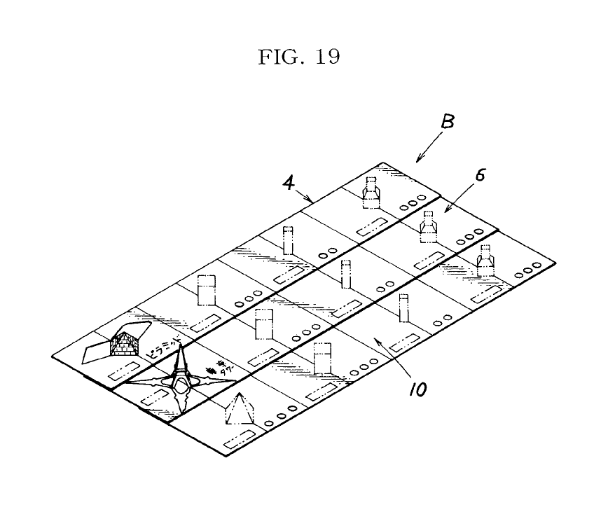

Embodiment 3 of the present invention is described in detail with reference being made to FIGS. 15 to 19.

The double-page spread structure B of the present embodiment has a first spreading part 4 obtained by serially linking a plurality of double-page spread parts 1 so as to be capable of being spread out in a prescribed direction, a second spreading part 6 obtained by serially linking a plurality of double-page spread parts 1 so as to be capable of being spread out in a prescribed direction, the second spreading part 6 being serially linked with the first spreading part 4 interposed by a medial part 15 and provided in parallel with the first spreading part 4, . . . , and an n^{th} spreading part (where n is a natural number of 2 or higher) obtained by serially linking a plurality of double-page spread parts 1 so as to be capable of being spread out in a prescribed direction, the n^{th} spreading part being serially linked with the n−1^{th} spreading part interposed by a medial part 15 and provided in parallel with the n−1^{th} spreading part. According to the present embodiment, there are as many as a third spreading part 10 that is serially linked to the second spreading part 6 interposed by the medial part 15 and provided in parallel with the second spreading part 6; however, the number of spreading parts can be changed as appropriate, with each spreading part being serially linked, interposed by a medial part 15.

The medial parts 15 via which the spreading parts are serially linked are composed of thin-band-shaped strips 16 and thin serial linking strips 17 that serially link the ends of the spreading parts and the ends of the thin band-shaped strips 16, as shown in FIG. 15.

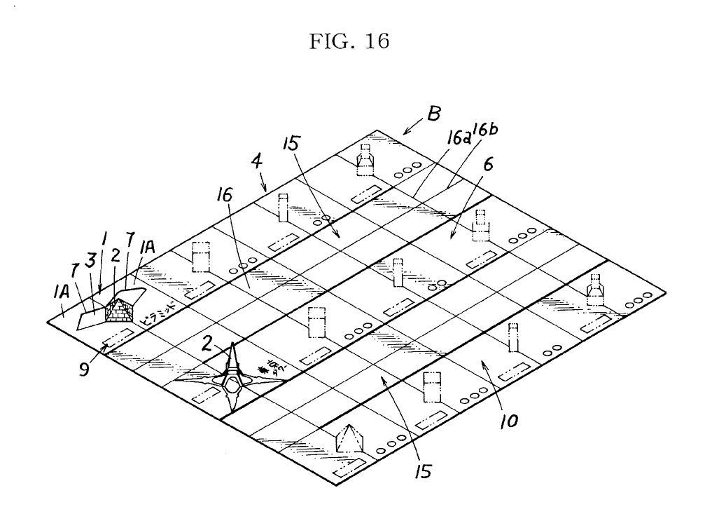

The thin band-shaped strips 16 are made of a suitable paper, as shown in FIGS. 15 and 16, and are set to the same length as the respective spreading parts.

The thin band-shaped strips 16 are provided with folded parts 16a (upward folding part and downward folding part) in the lengthwise direction at a spacing that is the same width as the page leafs 1A that constitute the double-page spread parts 1 of each of the spreading parts; and are configured to be folded up and stacked while being openable in the lengthwise direction.

The thin band-shaped strips 16 are provided with folding parts 16b in the center position in the widthwise direction so as to be folded up and stacked in half via the folding parts 16b.

Consequently, folding a folding part 16b of the thin band-shaped strip 16 and folding a folding part 17b of the thin serial linking strip 17 allows the spread-out spreading parts to be placed in a parallel state, adjacent to one another (refer to FIGS. 16 to 19). The medial parts 15 will then be placed in a concealed state as a result of the spreading parts being stacked thereon.

The thin serial linking strips 17 are the same as the fold-back parts 5 in Embodiment 1, and, as shown in FIG. 15, are made from appropriate paper, set to an area corresponding to two pages of page leafs 1A of the double-page spread part 1, and affixed to the back surface of the end part of the thin band-shaped strip 16 and the back surface of the page leaf 1A of the double-page spread part 1, positioned at the end of the spreading parts.

Consequently, the spreading parts and the thin band-shaped strips 16 are serially linked, interposed by the thin serial linking strips 17.

The thin serial linking strips 17 are provided with folding parts 17a in positions corresponding to the boundary between the end of the spreading part and the thin band-shaped strip 16.

The folding parts 17b are provided on the thin serial linking strips 17 at locations of overlap with the folding parts 16b of the thin band-shaped strips 16, and folding them along with the folding parts 16b of the thin band-shaped strips 16 described above enables the spreading parts that have been spread out to be placed in a parallel state adjacent to one another.

The medial parts 15 are provided between the spreading parts so that when the spreading parts are spread out, the text or graphics that are provided on the spreading parts will be oriented in the same direction without being reversed.

Specifically, the double-page spread structure B pertaining to the present embodiment can be viewed by spreading out each of the double-page spread parts 1 like a book. However, with a structure in which the spreading parts are folded back and serially linked in a serpentine configuration, the text or graphics provided on adjacent double-page spread parts 1 will be oriented in the reverse direction when each of the spreading parts is spread out in instances where the spreading parts are directly linked without being interposed by the medial parts 15.

According to the present embodiment, this problem can be reliably resolved by providing the medial parts 15 having the configuration described above, so that by spreading out each of the spreading parts, and folding and stacking the medial parts 15, the spreading parts will be stacked thereon so as to produce a concealed state. As a result, text or graphics that has been provided on the respective spreading parts can be conveniently oriented in the same direction, without being reversed.

In addition, the medial parts 15 may be used effectively as a location for providing explanations for the three-dimensional objects and the method for using the double-page spread structure B, or for other uses.

As with the spreading parts, a coating layer may be provided on the surfaces of the thin band-shaped strips 16 and the thin serial linking strips 17 pertaining to the medial parts 15.

Embodiment 3 is otherwise the same as Embodiments 1 and 2.

The present invention is not restricted to Embodiments 1, 2, and 3; the specific configurations of the constituent elements may be designed as appropriate.

What is claimed is:

1. A double-page spread structure having a plurality of double-page spread parts, wherein:
each of the double-page spread parts is configured so that side margin parts of opposing page leafs are serially linked, and the page leafs can be spread out and layered in a folded-over manner;
adjacent double-page spread parts are configured so that the side margin parts are serially linked and the double-page spread parts can be spread out as well as layered in a folded-over manner; and
a three-dimensional body that stands upright when the double-page spread part is opened is provided to each of the double-page spread parts, so that a configuration is obtained in which, when the page leaf and double-page spread parts are spread out, the three-dimensional bodies of each of the double-page spread parts are provided in parallel on a single flat surface.

2. The double-page spread structure according to claim 1, wherein the three-dimensional body is obtained by cutting out a part of the page leaf and causing the part to stand upright.

3. The double-page spread structure according to claim 2, wherein a cover leaf that covers the cut-out part of the page leaf is provided on a bottom surface of the page leaf.

4. The double-page spread structure according to claim 3, wherein the side margin parts of the adjacent double-page spread parts are serially linked and interposed by the cover leaf.

5. The double-page spread structure according to claim 1, wherein a coating layer made of a synthetic resin is provided on a surface of the page leaf.

6. The double-page spread structure according to claim 3, wherein a coating layer made of a synthetic resin is formed on a surface of the cover leaf.

7. The double-page spread structure according to claim 4, wherein a coating layer made of a synthetic resin is formed on the surface of the cover leaf.

8. The double-page spread structure according to claim 1, wherein each of the three-dimensional bodies is a three-dimensional object of a scaled-down real object such as a building or animal.

9. The double-page spread structure according to claim 1, having a first spreading part obtained by serially linking a plurality of double-page spread parts so as to be capable of being spread out in a prescribed direction, a second spreading part obtained by serially linking a plurality of double-page spread parts so as to be capable of being spread out in a prescribed direction, the second spreading part being serially linked with the first spreading part interposed by a fold-back part and provided in parallel with the first spreading part, . . . , and an n^{th} spreading part (where n is a natural number of 2 or higher) obtained by serially linking a plurality of double-page spread parts so as to be capable of being spread out in a prescribed direction, the n^{th} spreading part being serially linked with the n−1^{th} spreading part interposed by a fold-back part and provided in parallel with the n−1^{th} spreading part.

10. The double-page spread structure according to claim 1, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

11. The double-page spread structure according to claim 2, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

12. The double-page spread structure according to claim 3, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

13. The double-page spread structure according to claim 4, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

14. The double-page spread structure according to claim 5, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

15. The double-page spread structure according to claim 6, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

16. The double-page spread structure according to claim 7, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

17. The double-page spread structure according to claim 8, having a first spreading part obtained by serially linking a plurality of double-page spread parts so as to be capable of being spread out in a prescribed direction; and a second spreading part obtained by serially linking a plurality of double-page spread parts so as to be capable of being spread out in a prescribed direction, the second spreading part being serially linked with the first spreading part interposed by a fold-back part and provided in parallel with the first spreading part.

18. The double-page spread structure according to claim 1, wherein a plurality of double-page spread parts are serially linked so as to be capable of being spread out in an annular configuration.

19. The double-page spread structure according to claim 2, wherein a plurality of double-page spread parts are serially linked so as to be capable of being spread out in an annular configuration.

20. The double-page spread structure according to claim 3, wherein a plurality of double-page spread parts are serially linked so as to be capable of being spread out in an annular configuration.

21. The double-page spread structure according to claim 4, wherein a plurality of double-page spread parts are serially linked so as to be capable of being spread out in an annular configuration.

22. The double-page spread structure according to claim 5, wherein a plurality of double-page spread parts are serially linked so as to be capable of being spread out in an annular configuration.

23. The double-page spread structure according to claim 6, wherein a plurality of double-page spread parts are serially linked so as to be capable of being spread out in an annular configuration.

24. The double-page spread structure according to claim 7, wherein a plurality of double-page spread parts are serially linked so as to be capable of being spread out in an annular configuration.

25. The double-page spread structure according to claim 8, wherein a plurality of double-page spread parts are serially linked so as to be capable of being spread out in an annular configuration.
